(19) United States
(12) Patent Application Publication
(10) Pub. No.: US 2022/0397901 A1
(43) Pub. Date: Dec. 15, 2022

(54) TRASH COLLECTION SYSTEM AND TRASH COLLECTION METHOD

(71) Applicant: TOYOTA JIDOSHA KABUSHIKI KAISHA, Toyota-shi (JP)

(72) Inventors: Nobuhisa OTSUKI, Toyota-shi (JP); Haeyeon Lee, Tokyo-to (JP); Kunihiro Iwamoto, Nagakute-shi (JP); Yuta Itozawa, Nagoya-shi (JP); Hirotaka Komura, Tokyo-to (JP); Yutaro Takagi, Tokyo-to (JP); Kota Oishi, Yokohama-shi (JP)

(73) Assignee: TOYOTA JIDOSHA KABUSHIKI KAISHA, Toyota-shi (JP)

(21) Appl. No.: 17/833,211

(22) Filed: Jun. 6, 2022

(30) Foreign Application Priority Data
Jun. 10, 2021 (JP) 2021-097502

(51) Int. Cl. G05D 1/00; B65F 1/02; B65F 3/00; G06Q 10/00

(52) U.S. Cl. CPC G05D 1/0088; B65F 1/02; B65F 3/00; G06Q 10/30; B65F 2210/128; B65F 2210/138

(57) ABSTRACT

A system includes a trash box, a data acquiring device, a computer of a facility, a mobile, and a management server. The trash box is placed in a space facing a road for the mobile in the facility. The data acquiring device acquires collection status data of a trash in the trash box. The management server or the computer of the facility determines whether a collection of the trash box is required based on comparing a judgment element calculated by using a collection status data with a judgment threshold. The management server transmits a collection order to the mobile if it is determined that the collection of trash box is required. The mobile comprises an automatic collection device. The automatic collection device performs an automated replenishment control of the trash box if the mobile receives the collection order.

The present application claims priority under 35 U.S.C. § 119 to Japanese Patent Application No. 2021-97502, filed on Jun. 10, 2021, the contents of which application are incorporated herein by reference in their entirety.

### TECHNICAL FIELD

The present disclosure relates to a system and a method to collect a trash discarded by a facility automatically.

### BACKGROUND

JP2005-8339A discloses a system to collect a trash (a household garbage) discarded by a home. In the conventional system, a garbage collection bag containing the trash is collected by a garbage truck. An IC tag code is attached to the garbage collection bag. In the IC tag code, information on a capacity of the garbage collection bag and information on a content (types of the trashes) of the garbage collection bag are recorded.

The garbage truck has an IC tag reader and a GPS device. The IC tag reader reads the information of the IC tag code at the collection of the garbage collection bag by the garbage truck. The GPS device acquires positional information of the garbage truck. The garbage truck transmits the information and positional information of the IC tag code to a management server. The management server grasps a collection status of the trash based on the information received from the garbage truck.

Consider operations after the trash is discarded to the garbage collection bag and before the collection by the garbage truck. A household garbage is carried by a resident to a predetermined collection area outside the residence. The view about the trash discarded by a store (i.e., a business garbage) is the same as that of the household garbage. That is, a business garbage is carried to a predetermined collection area outside the store by an employee of the store. In any case, the trash is carried by a person to a predetermined collection area outside a facility, such as the residence or the store. If a discard time zone is specified, the trash is carried in accordance with this specified time zone.

The trash carried to the predetermined collection area is loaded into the garbage truck by an occupant of the garbage truck. In other words, the human intervenes also at the collection of the trash by the garbage truck. Thus, manual works (i.e., the transport and loading) occur after the trash is discarded and before the collection by the garbage truck. Therefore, it is desired to develop a new technique for reducing the labor of humans involved in such manual work.

It is an object of the present disclosure to provide a new technique that can reduce the labor of humans involved in the collection of the trash discarded by the facility.

### SUMMARY

A first aspect is a system to collect a trash discarded by a facility and has the following features.

The system includes a trash box, a data acquiring device, a computer of the facility, a mobile, and a management server. The trash box is placed in a space facing a road for the mobile in the facility. The data acquiring device configured to acquire collection status data of a trash in a trash box installed in the space. The mobile includes an automatic collection device of the trash box. The management server configured to communicate with the mobile and the computer of the facility.

The management server or the computer of the facility configured to determine whether a collection of the trash box installed in the space is required based on a comparison a judgment element calculated based on the collection status data with a judgment threshold set for each judgment element.

When it is determined that collection of the trash box installed in the space is required, the management server transmits a collection order to collect the trash box as a container to be collected to the mobile.

The automatic collection device is configured to execute automated replenishment control of the container to be collected in the installation space of the container to be collected if the mobile receives the collection order.

A second aspect further has the following features in the first aspect.

The mobile further includes an automated driving device.

The automated driving device is configured to execute first automated driving control from a current location of the mobile to the installation space and second automated driving control from the installation space to a trash collection point when the mobile receives the collection order.

A third aspect further has the following features in the first aspect.

The container to be collected includes at least two types of trash boxes set according to types of trashes.

The management server or the computer of the facility individually determines for each of the at least two types of the trash boxes whether the collection of the trash box is required based on the comparison between the judgment element with the judgment threshold set for each judgment element.

A default value of the judgment threshold is individually set according to the types of trashes.

A fourth aspect further has the following features in the first aspect.

A default value of the judgment threshold is individually set according to the types of trashes.

When the management server receives a request for changing the judgment threshold the from facility, the management server is configured to change the judgment threshold to a value other than a default value in response to the request.

A fifth aspect further has the following features in the first aspect.

The facility includes a first facility and a second facility.

The mobile includes a first mobile and a second mobile.

The trash box includes a first trash box installed in the space of the first facility and a second trash box installed in the space of the second facility.

The management server is configured to:

if it is determined that the collection of the first trash box is required, transmit a first collection order that is the collection order for the first trash box to the first mobile;

if it is determined that the collection of the second trash box is required during the collection of the first trash box by the first mobile based on the first collection order, determine whether a return condition for the first mobile is satisfied;

if it is determined that the return condition is satisfied, transmit a second collection order that is the collection order for the second trash box to the first mobile; and

if it is determined that the return condition is not satisfied, transmit the second collection order to the second mobile.

A sixth aspect further has the following features in the first aspect.

The judgment element is at least one selected from a weight of the container to be collected, an accommodation rate of the trash in the container to be collected, a residence time of the trash in the container to be collected, and a concentration of a specific gas around the container to be collected.

A seventh aspect is a method to collect a trash discarded by a facility by collecting a trash box installed in a space facing a road for a mobile in a facility by a mobile, and has the following features.

The facility comprises a data acquiring device. The data acquiring device configured to acquire collection status data of a trash in a trash box installed in the space. The mobile includes an automatic collection device of the trash box.

A management server or a computer of the facility determines whether a collection of the trash box installed in the space is required based on a comparison a judgment element calculated based on the collection status data with a judgment threshold set for each judgment element.

When it is determined that collection of the trash box installed in the space is required, the management server transmits a collection order to collect the trash box as a container to be collected to the mobile.

The automatic collection device executes automated replenishment control of the container to be collected in the installation space of the container to be collected if the mobile receives the collection order.

An eighth aspect has the following further features in seventh aspect: The mobile further includes an automated driving device.

The automated driving device executes first automated driving control from a current location of the mobile to the installation space and second automated driving control to a trash collection point when the mobile receives the collection order.

According to the first or seventh aspect, the trash box is installed in the space facing road for the mobile in the facility. This frees the trash box from the manual operation to carry it out of the facility to a predetermined collection area. Therefore, the labor of humans in the facility can be reduced. In addition, according to the first or seventh aspect, if the mobile receives the collection order, the automated replenishment control is executed in the installation space of the container to be collected. That is, the loading of the container to be collected to the mobile is automatically performed the in the installation space. It is thus released from the manual loading of the container to be collected. Therefore, the labor of the occupant of the mobile can be reduced.

According to the second or eighth aspect, an outbound travel from the current location of the mobile to the installation space and a return travel from the installation space to trash collection point are performed autonomously. Thus, the mobile can be operated automatedly and thus it is possible to increase the degree of freedom in collecting the trash box by the mobile.

According to the third aspect, it is possible to collect the trash flexibly based on the judgment threshold individually set according to types of trashes.

According to the fourth aspect, it is possible to collect the trash in accordance with the preference of the human of the facility. For example, if a resident desires an immediate collection of the trash, the resident may change the judgment threshold to allow an immediate dispatch of the mobile.

According to the fifth aspect, it is possible to collect the second trash box after the collection of the first trash box by the first mobile. Therefore, it is possible to collect the first and second trash boxes efficiently.

According to the sixth aspect, it is possible to determine whether the collection of the trash box is re is required based on at least one selected from the weight of the container to be collected, the accommodation rate of the trash in the container to be collected, the residence time of the trash in the container to be collected, and the concentration of the specific gas around the container to be collected.

### BRIEF DESCRIPTION OF DRAWINGS

FIG. 1 is a diagram illustrating a premise of collection and replenishment service of a trash box;

FIG. 2 is a diagram illustrating an outline of a collection and replenishment service;

FIG. 3 is a schematic diagram showing an interior configuration example of a mobile;

FIG. 4 is a diagram explaining another example of the collection and replenishment service;

FIG. 5 is a block diagram illustrating a configuration example of a management server;

FIG. 6 is a block diagram illustrating a configuration example of a mobile;

FIG. 7 is a block diagram illustrating a configuration example of a facility;

FIG. 8 is a flowchart illustrating an example of processing executed by a data processing device of the facility;

FIG. 9 is a flowchart illustrating an example of processing executed by a data processing device of the management server; and

FIG. 10 is a flowchart illustrating an example of processing executed by a controller of a mobile.

### DESCRIPTION OF EMBODIMENT

Hereinafter, a collection system and a collection method of a trash according to an embodiment of the present disclosure will be described with reference to the drawings. Note that the collection method according to the embodiment is realized by computer processing executed in the collection system according to the embodiment. In the drawings, the same or corresponding portions are denoted by the same sign, and descriptions thereof are simplified or omitted.

### 1. Outline of Embodiment

### 1-1. Assumption

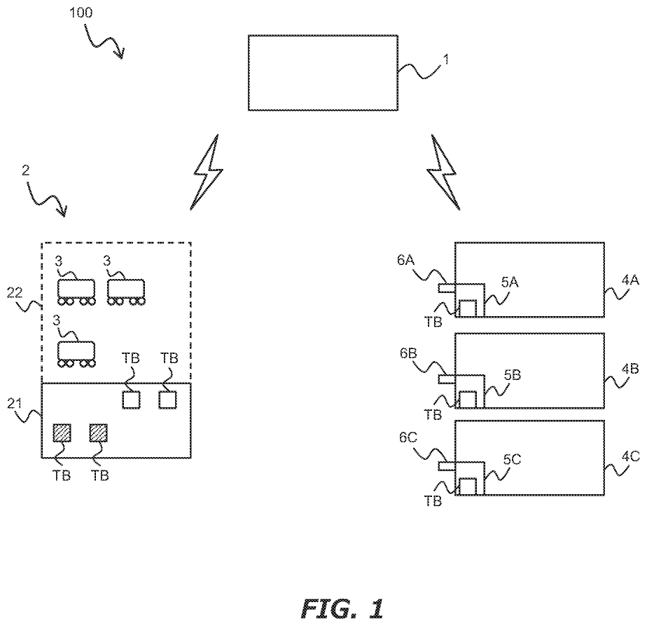

The collection system according to the embodiment is a system to perform a collection and replenishment service of a trash box TB. FIG. 1 is a diagram illustrating a premise of this collection and replenishment service. As shown in FIG. 1, a collection system 100 includes a management server 1, a trash collection point 2, a plurality of mobiles 3, and facilities 4A to 4C. Hereinafter, for convenience of explanation, the facilities 4A to 4C are collectively referred to as a “facility 4” except for a case where the facilities 4A to 4C are particularly limited.

The management server 1 controls the entire collection and replenishment service. The management server 1 communicate with the trash collection point 2, the plurality of mobiles 3 and the facility 4 via a network, respectively.

The trash collection point 2 includes a trash disposal area 21 and a standby area 22. In the trash disposal area 21, an unloading of the trash box TB from the mobile 3 is performed. In the trash disposal area 21, also, the trash is removed from the trash box TB and disposed of. In the trash disposal area 21, also, a loading of a vacant trash box TB to the mobile 3 is performed. In the standby area 22, the plurality of mobiles 3 waiting for the unloading or loading of the trash box TB or an operation instruction of the collection and replenishment service are waiting. The trash collection point 2 communicates with the plurality of mobiles 3 via the network separately.

Each of the plurality of mobiles 3 collects the trash box TB from the facility 4 in accordance with the operation instruction (a collection order). Each of the plurality of mobiles 3 replenishes the facility 4 with the vacant trash box TB according to the operation instruction (a replenishment order). An occupant (a driver) may or may not ride on each of the plurality of mobiles 3. Each of the plurality of mobiles 3 includes an automated driving device and an automated collection and replenishment device of the trash box TB. The automated driving device executes automated driving control for performing an autonomous travel of an outbound route from the current location of the mobile 3 (e.g., the standby area 22) to the facility 4 (e.g., the facility 4A) and automated driving control for performing an autonomous travel of a return route from this facility 4 to the trash collection point 2 (e.g., the standby area 22). The automated driving device may perform control to move along the outbound route and the return route based on a remote assistance by an operator. The automated collection and replenishment device executes automated collection and replenishment control of the trash box TB on the facility 4.

Each of the facilities 4A to 4C is equipped with a space (spaces 5A to 5C) in which the trash box TB is installed. Hereinafter, for convenience of explanation, the spaces 5A to 5C are collectively referred to as an “installation space 5” except when the spaces 5A to 5C is particularly limited. The installation space 5 is provided facing a road for a mobile in the facility 4. At least one trash box TB is installed in each installation space 5. The trash box TB is provided by a business operator of the collection and replenishment service. The trash box TB is, for example, a container made of resin or stainless-steel. The trash box TB may include a lidding.

In the installation space 5, two or more trash box TB may be installed depending on types of trashes. Examples of the types of trashes include a combustible garbage, a non-burnable garbage, and a particular garbage (e.g., recyclable garbage, bins, and cans). The trash box TB is configured to be identifiable as the types of trashes. For example, trash box TB is colored with an identification color corresponding to the types of trashes. In another example, an outer surface of the trash box TB is provided with an identification sign corresponding to the types of trashes. Examples of the identification sign include a bar code, a two-dimensional code such as a QR code (registered trademark), and a RFID (Radio Frequency Identification) tag.

In the installation space 5, the automated collection and replenishment control by the mobile 3 is executed. Each of the facilities 4A to 4C is equipped with a data acquiring device (data acquiring devices 6A to 6C). Each of the data acquiring devices 6A to 6C acquires data of a collection status of the trash in the trash box TB installed in each of the spaces 5A to 5C. Hereinafter, for convenience of explanation, the data acquiring devices 6A to 6C are collectively referred to as a “data acquiring device 6” except when the data acquiring devices 6A to 6C are particularly limited.

### 1-2. Collection and Replenishment Service

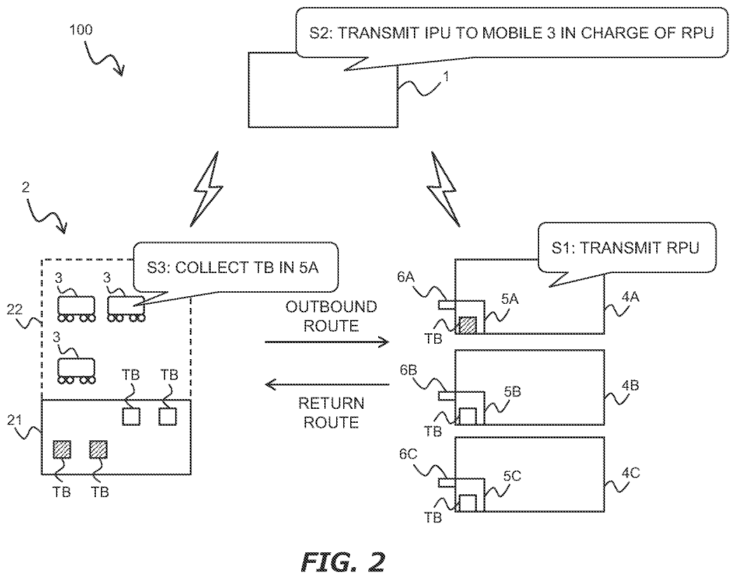

FIG. 2 is a diagram illustrating an outline of a collection and replenishment service. In the example shown in FIG. 2, a flow of a collection service of the trash box TB installed in the space 5A is described. In this collection service, first, the facility 4A transmits a collection request RPU (Request for Pick-Up) to the management server 1 (step S1). The collection request RPU is transmitted when it is determined that a collection is required based on the data of the collection status acquired by the data acquiring device 6A.

The collection request RPU includes location data (e.g., latitude and longitude data) of the facility 4A (of the space 5A), number data of the trash box TB to be collected, and type data of the trash box TB to be collected (i.e., data of the types of trashes). The details of the step S1 will be described later.

In the example shown in FIG. 2, the management server 1 also selects a mobile 3 in charge of the collection request RPU and transmits a collection order IPU (an instruction for Pick-Up) to the selected mobile 3 (step S2). The collection order IPU includes the location data of the facility 4A (or the space 5A) in which the trash box TB to be collected is installed, the number data of the trash box TB to be collected, and the type data of the trash box TB. The collection order IPU may include the location data of the outbound route and return route. Details of the step S2 will also be described later.

Note that, in the step S1, the collection request RPU may not be transmitted from the facility 4A to the management server 1. In this case, the Facility 4A transmits the data of the collection status to the management server 1. And the management server 1 determines whether there is the collection request RPU from the facility 4A based on the data of the collection status. If it is determined that there is the collection request RPU from the facility 4A, the mobile 3 in charge of this request is selected and the collection order IPU is transmitted in the step S2.

In the example shown in FIG. 2, the collection of the trash box TB by the mobile 3 is also performed (step S3). The mobile 3 travels along the outbound route from the current location (e.g., the standby area 22) of the mobile 3 to the facility 4A (the space 5A) in accordance with the collection order IPU. When arriving at the facility 4A, the mobile 3 performs the collection of the trash box TB in the space in accordance with the collection order IPU. After the collection of the trash box TB, the mobile 3 travels along the return route from the facility 4A (the space 5A) to the trash collection point 2 in accordance with the collection order IPU. Details of the step S3 will also be described later.

In the example shown in FIG. 2, the replenishment of the vacant trash box TB may be performed by the mobile 3 simultaneously with the collection of the trash box TB. The management server 1 transmits a replenishment order IRS (Instruction for Re-Stocking) to the mobile 3. The replenishment of the vacant trash box TB may be performed by another mobile 3 different from the mobile 3 in charge of the collection of the trash box TB. In this case, the management server 1 transmits the replenishment order IRS to the said another mobile 3.

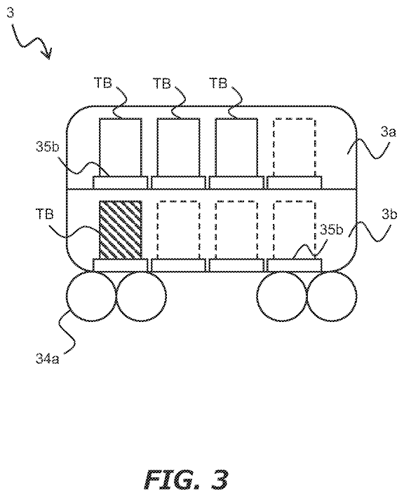

FIG. 3 is a schematic diagram showing an interior configuration example of the mobile 3. In the example shown in FIG. 3, an interior space of the mobile 3 is divided into an upper space 3a and a lower space 3b. The upper space 3a accommodates for the vacant trash box TB (i.e., the trash box TB to be replenished with the facility 4). The lower space 3b accommodates for the trash box TB containing the trash (i.e., the trash box TB collected from the facility 4). According to the configuration example shown in FIG. 3, the replenishment of the vacant trash box TB can be performed simultaneously with the collection of the trash box TB containing the trash. Examples of operations of the automated collection and replenishment device included in the mobile 3 will be described later.

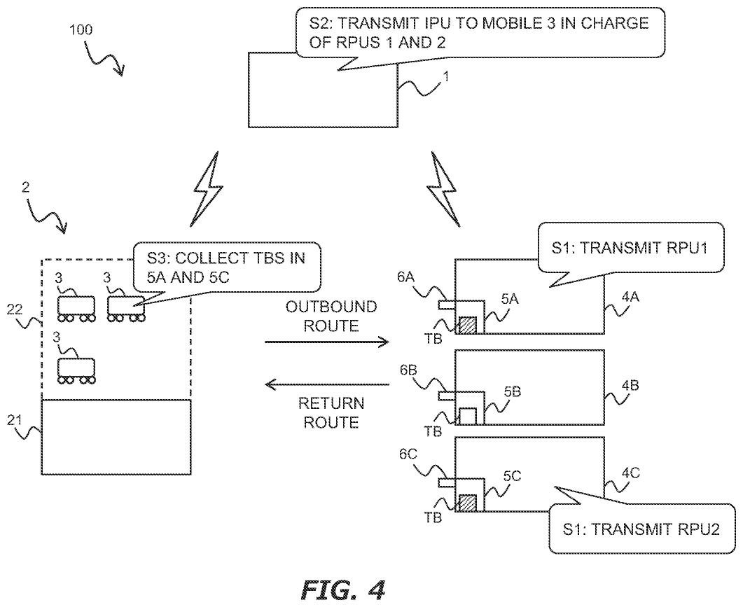

FIG. 4 is a diagram illustrating another example of the collection and replenishment service. In the example shown in FIG. 4, a flow of the collection service if the two trash boxes TB installed in the spaces 5A and 5C is described. In the example shown in FIG. 4, the facility 4A transmits the management server 1 the collection request RPU1 and the facility 4C transmits the collection request RPU2 to the management server 1 (step S1). The collection requests RPU1 and RPU2 are transmitted at approximately the same time.

Note that the collection requests RPU1 and RPU2 need not be transmitted from the facility 4A to the management server 1. In this case, the data of the collection status is transmitted to the management server 1 from the facilities 4A and 4C, respectively.

In the example shown in FIG. 4, the management server 1 also selects two mobiles 3 in charge of the collection requests RPU1 and RPU2 and two collection order IPUs are transmitted to the selected two mobiles 3 respectively (step S2). The explanation of the collection order IPU has already been described above.

In the example shown in FIG. 4, the collection of the trash box TB by the two mobiles 3 is performed respectively (step S3). Each of the two mobile 3 travels along, for example, the route from the current location of respective mobile 3 to respective facility 4 (i.e., the facility 4A or 4C). When arriving at the respective facility 4(i.e., the facility 4A or 4C), the respective mobile 3 performs the collection of the trash box TB in respective installation space 5 (i.e., the space 5A or 5C). After the collection of the trash box TB, the respective mobile 3 travels along the return route from the respective facility 4(i.e., the facility 4A or 4C) to respective trash collection point 2.

In the example shown in FIG. 4, the mobile 3 in charge of the collection request RPU1 may be responsible for the collection request RPU2. In this case, the mobile 3 travels along the route from the current location of mobile 3 to the facility 4A. When arriving at the facility 4A, the mobile 3 performs the collection of the trash box TB in the space 5A. After the collection of the trash box TB, the mobile 3 travels along a route from the facility 4A to the facility 4C. When arriving at the facility 4C, the mobile 3 performs the collection of the trash box TB in the space 5C. After the collection of the trash box TB, the mobile 3 travels along the return route from the facility 4C to the trash collection point 2.

In the example shown in FIG. 4, the transmission of the collection requests RPU1 and RPU2 may be transmitted at intervals. For example, after transmitting the collection order IPU to the mobile 3 in charge of the collection request RPU1, the collection request RPU2 may be accepted in the management server 1 prior to this mobile 3 returning to the trash collection point 2. In this case, the management server 1 selects another mobile 3 in charge of the collection request RPU2. The mobile 3 in charge of the collection request RPU1 may be selected as the said another mobile 3 in charge of the collection request RPU2.

As described above, according to the collection system 100, the trash box TB installed in the installation space 5 is collected by the mobile 3. The installation space 5 is located in the facility 4. This frees the trash box TB from a manual operation of carrying it out of the facility 4 to a predetermined collection area. Therefore, the labor of the human in the facility 4 can be reduced. In addition, in the installation space 5, a loading of the trash box TB to the mobile 3 and an unloading of the vacant trash box TB are autonomously performed by the mobile 3. Therefore, the labor of the occupant of the mobile 3 can be reduced. Furthermore, according to the collection system 100, the travel of the mobile 3 along the outbound route and the return route is performed autonomously. Therefore, it is possible to drive the mobile 3 unattended to enhance the convenience of the collection and replenishment service.

Hereinafter, the collection system according to the embodiment will be described in detail.

### 2. Collection System

### 2-1. Configuration Example of Management Server

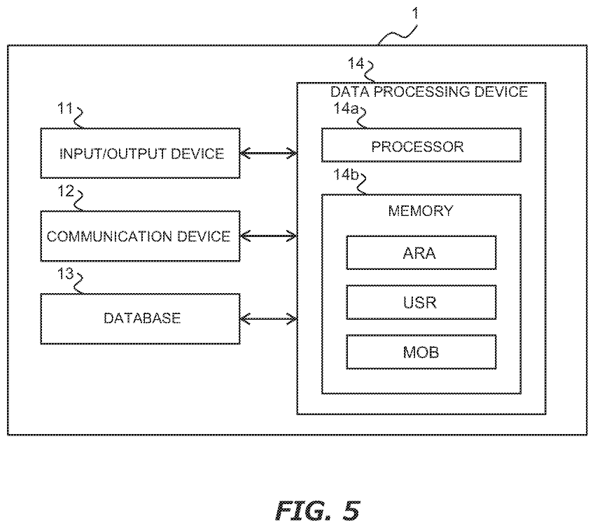

FIG. 5 is a block diagram illustrating a configuration example of the management server 1. As shown in FIG. 5, the management server 1 includes an input/output device 11, a communication device 12, a data base 13, and a data processing device 14. The data processing device 14 and the input/output device 11, the communication device 12 and the data base 13 are connected by a predetermined network.

The input/output device 11 is an interface to receive input information from an operator of the management server 1 and provide information to the operator. Examples of the input device include a keyboard, a mouse, a touch panel, a switch and a microphone. Examples of the output device include a display device and a speaker. The operator monitors an operation state of the collection and replenishment service based on the information provided through the output device. The operator may perform a remote assistance of the travel of the mobile 3 based on the information provided through the output device. Examples of the remote assistance include a recognition support, a judgment support, and a remote operation. When the remote assistance is performed, a remote assistance signal generated based on the signal inputted from the input device is transmitted to the mobile 3 via the communication device 12.

The communication device 12 communicates with a device outside of the management server 1. For example, the communication device 12 communicates with a computer of the trash collection point 2 (e.g., a tablet, a smart phone) through a wireless communication network such as 4G and 5G. The communication device 12 also communicates with a computer of the mobile 3 (e.g., the controller 33 described below) through the wireless communication network. The communication device 12 also communicates with a computer of the facility 4 (e.g., the data processing device 44 described below) through the wireless communication network.

The database 13 is formed in a predetermined memory device (e.g., a hard disk, a flash memory). In the database 13, various data required for the collection and replenishment service is stored. Examples of the various data include data of service area configuration ARA, data of user USR and data of mobile MOB.

The service area configuration data ARA is data related to a configuration of a service area (e.g., one city) in which the collection and replenishment service is provided. Examples of the configuration of the service area include location data of roads, location data of the facility 4, and location data of the installation space 5. The service area configuration data ARA has been created in advance. The service area configuration data ARA may be updated at regular intervals.

The user data USR is data related to a user (e.g., the facility) of the collection and replenishment service. Examples of the use data USR, registration data such as ID data and location data of the respective facility. A person of the facility 4 (e.g., an employee of a store, a resident of a house, etc.) operates the computer of the facility 4 to input the data for the registration. The computer of the facility 4 transmits the data for the registration to the management server 1. The management server 1 receives this data for the registration via the communication device 12 and stores it in the data base 13.

The mobile data MOB is data related to the mobile 3. The mobile data MOB is generated for each mobile 3. Examples of the mobile data MOB include data of an operation state of the mobile 3, data of a location of the mobile 3, and data of a storing state of the trash box TB. Examples of the operation state include “in operating” in accordance with the operation instruction (e.g., the collection order and the replenishment order), “waiting” for the operation instruction, and “in trouble with traffic (e.g., a stalled state)” and “in trouble with control device”. Examples of the storing state include the number of the trash box TBs containing the trash and the number of the vacant trash box TBs.

The data processing device 14 is a computer that executes various data processing related to the collection and replenishment service. As a configuration for executing the various data processing, the data processing device 14 includes at least one processor 14a and at least one memory 14b. The processor 14a includes a CPU (Central Processing Unit). The memory 14b is a volatile memory such as a DDR memory, and develops program used by the processor 14a and stores various data temporarily. The various data include the service area configuration data ARA, the user data USR and the mobile data MOB read from the database 13. Examples of the processing executed by the data processing device 14 will be described later.

### 2-2. Configuration Example of the Mobile

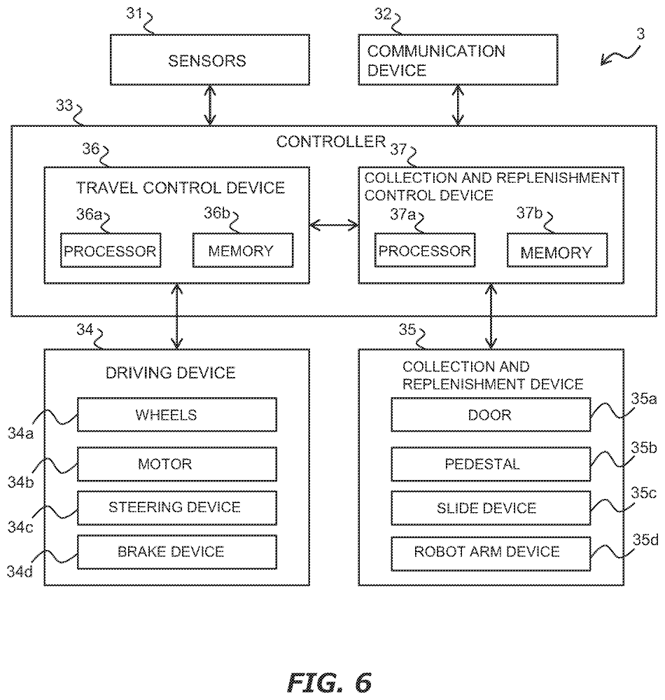

FIG. 6 is a diagram illustrating a configuration example of the mobile 3. As shown in FIG. 6, the mobile 3 includes sensors 31, a communication device 32, a controller 33, a driving device 34, and a collection and replenishment device 35. The controller 33 and elements such as the sensors 31 are connected by an on-board network (for example, a CAN (Controller Area Network)).

The sensors 31 include a position sensor, a status sensor, and a recognition sensor. The position sensor acquires data of a position and an orientation of the mobile 3. Examples of the position sensor include a GNSS (Global Navigation Satellite System) receiver. The status sensor detects velocity, acceleration (e.g., longitudinal acceleration and lateral acceleration), yaw rate, a load weight, a remaining battery amount of the mobile 3. The recognition sensor recognizes a condition surrounding the mobile 3. Examples of the recognition sensor include a camera, a millimeter wave radar, and a LiDAR (Light Detection And Ranging). The recognition sensor may include a reader that reads an identification sign such as a bar code, a RFID tag, and the like.

The communication device 32 communicates with a device outside of the mobile 3. For example, the communication device 32 communicates with the management server 1 through a wireless communication network such as 4G and 5G. The communication device 32 also communicates with the computer of the trash collection point 2 through the wireless communication network. The communication device 32 also communicates with the computer of the facility 4 (e.g., the data processing device 44 described below) through the wireless communication network.

The controller 33 is a computer that controls the mobile 3. The controller 33 includes a travel control device 36 and a collection and replenishment control device 37. The travel control device 36 is a computer that controls the driving device 34. The driving device 34 and the travel control device 36 constitute the “automated driving device” of the present disclosure. The collection and replenishment control device 37 is a computer that controls the collection and replenishment device 35. The collection and replenishment device 35 and the collection and replenishment control device 37 constitute the “automatic collection device” of the present disclosure. Examples of the processing executed by the data processing device 33 will be described later.

The travel control device 36 includes at least one processor 36a and at least one memory 36b as a configuration for controlling the driving device 34. The collection and replenishment control device 37 includes at least one processor 37a and at least one memory 37b as a configuration for controlling the collection and replenishment device 35. The configuration of the processor 36a or 37a is essentially the same as that of the processor 14a. The configuration of the memory 36b or 37b is essentially the same as that of the memory 14b.

The driving device 34 accelerates, decelerates, and steers the mobile 3. The driving device 34 includes wheels 34a, a motor 34b, a steering device 34c, and a brake device 34d. The motor 34b drives the wheels 34a. The steering device 34c turns the wheels 34a. The brake device 34d applies a braking force to the mobile 3. The acceleration of the mobile 3 is realized by controlling the motor 34b. The deceleration of the mobile 3 is realized by controlling the brake device 34d. The braking of mobile 3 may be realized by using a regenerative brake under the control of the motor 34b. The steering of the mobile 3 is realized by controlling the steering device 34c.

The collection and replenishment device 35 loads the trash box TB installed in the installation space 5 into the mobile 3. The collection and replenishment device 35 is also unloaded the vacant trash box TB from mobile 3 and placed on the installation space 5. The collection and replenishment device 35 includes a door 35a of the mobile 3, a pedestal 35b of the trash box TB, a slide device 35c, and a robot arm device 35d.

The door 35a is provided on a opening (not shown) of the mobile 3. During the travel of the mobile 3, the door 35a is closed. During the loading of the trash box TB and the unloading of the vacant trash box TB, the door 35a is opened. The slide device 35c moves the pedestal 35b in a horizontal direction while the door 25a is opened. When the pedestal 35b is moved in the horizontal direction, the pedestal 35b is pulled out to the side of the mobile 3, or the pulled-out pedestal 35b is accommodated in the mobile 3. Examples of the slide device 35c include a conveyor and a roller. The slide device 35c may have a function to move the pedestal 35b vertically. The robot arm device 35d grasps the trash box TB installed in the installation space 5 and moves it onto the pedestal 35b. The robot arm device 35d grasps the vacant trash box TB on the pedestal 35b and moves it to the installation space 5.

### 2-3. Configuration Example of the Facility

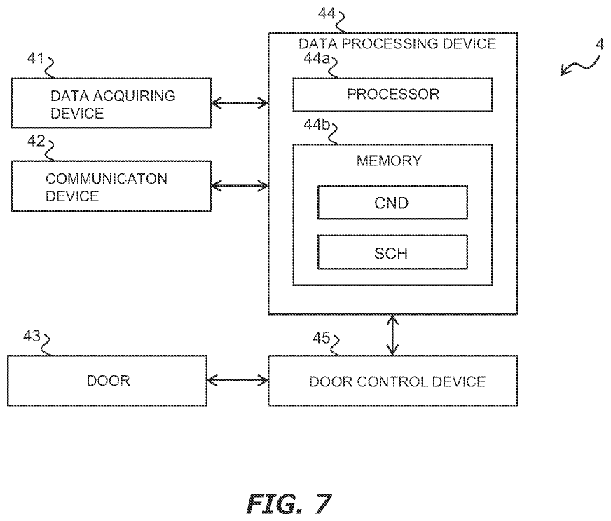

FIG. 7 is a block diagram illustrating a configuration example of the facility 4. As shown in FIG. 7, the facility 4 includes a data acquiring device 41, a communication device 42, a door 43, a data processing device 44, and a door controller 45. The data processing device 44 and the data acquiring device 41 and the communication device 42 are connected by a predetermined network. The door 43 and the door controller 45 are connected to each other by a predetermined network. The data processing device 44 and the door controller 45 are connected by a wireless communication network.

The data acquiring device 41 obtains data of collection status CND of the trash in the trash box TB. Examples of the collection status data CND include a weight of the trash box TB, an accommodation rate of the trash in the trash box TB, a residence time of the trash discarded in the trash box TB, and a concentration (or a smell level) of a specific gas around the trash box TB.

Examples of the data acquiring device 41 for acquiring the weight include a weight sensor. The accommodation rate is expressed, for example, by a percentage assuming that the volume of the vacant trash box TB is 100% The accommodation rate is calculated based on a total volume of the trash in the trash box TB or a position of a top surface of the trash. Examples of the data acquiring device 41 for acquiring the total volume and the top position include a camera. Examples of the data acquiring device 41 for acquiring the top position include a range sensor. The residence time indicates a time elapsed since the trash was dumped in the vacant trash box TB. Examples of the data acquiring device 41 for acquiring the residence time include the camera. Examples of the data acquiring device 41 for acquiring the concentration of the specific gas include a gas sensor.

The communication device 42 communicates with a device outside of the facility 4. For example, the communication device 42 communicates with the management server 1 through a wireless communication network such as 4G and 5G. The communication device 42 also communicates with the computer of the mobile 3 (e.g., the controller 33 described below) through the wireless communication network.

The door 43 separates the road for the mobile in the facility 4 from the installation space 5. Normally, the door 43 is closed. When the door 43 is opened, the road for the mobile and the installation space 5 in the facility 4 are connected. During the loading of the trash box TB to the mobile 3 and during the unloading of the vacant trash box TB from the mobile 3, the door 43 is opened. The door 43 is controlled by the door controller 45.

The data processing device 44 is a computer that executes various data processing related to the collection and replenishment service. As a configuration for executing the various data processing, the data processing device 44 includes at least one processor 44a and at least one memory 44b. The constituent of processor 44a is essentially the same as that of processor 14a. The configuration of memory 44b is essentially the same as that of memory 14b.

In the memory 44b, collection status data CND is stored. Further, in the memory 44b, schedule data SCH is stored. The schedule data SCH indicates regular a collection and replenishment schedule of the trash box TB. The regular collection and replenishment schedule includes data of day of week and time zone. The regular collection and replenishment schedule is set for each type of the trash box TB.

### 3. Processing Example

### 3-1. Details of the Step S1

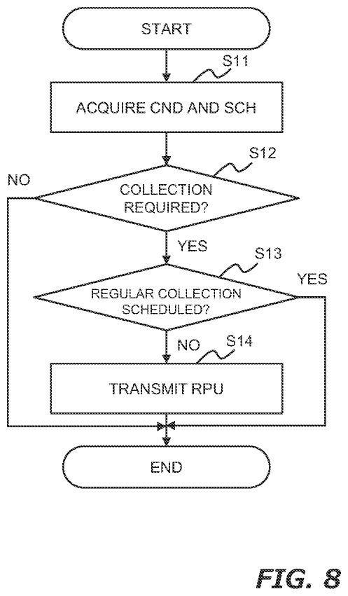

FIG. 8 is a flowchart illustrating an example of processing executed by the data processing device 44 (the processor 44a) of the facility 4. The routine shown in FIG. 8 is repeatedly executed at a predetermined control cycle.

In the routine shown in FIG. 8, first, the collection status data CND and the schedule data SCH are acquired (step S11). The collection status data CND is data of the collection status of the trash in the trash box TB and is acquired for each trash box TB. The explanation of the collection status data CND has already been described above.

After the processing of the step S11, it is determined whether the collection of the trash box TB is required (step S12). In the processing of the step S12, first, a judgment element is calculated based on the collection status data CND acquired in the step S11. The judgment element is at least one selected from the weight, the accommodation rate, the residence time and the concentration (or the smell level) of the specific gas. In the processing of the step S12, the calculated judgment element is compared with a judgment threshold. The judgment threshold is set for each type of the trash box TB.

The default value of the judgment threshold is preset in the management server 1. This default value can be changed in response to a change request from the facility 4. By changing the default value, it is possible to set the replenishment cycle in accordance with the preference of the human of the facility 4. Note that, if the judgment threshold is changed to a value other than the default value, incentives for the collection and replenishment service may be given to the facility 4. For example, if the judgment threshold is changed to extend the replenishment cycle, a charge for use of the collection and replenishment service may be discounted. Or, when transmission timing of the collection request RPU from the facility 4 is overlapped with that transmitted from another facility, a distribution priority of the mobile 3 for the former may be increased as compared with the latter.

Consider a case where the judgment element is the weight. If the weight exceeds an allowable weight, it is determined that the collection of the trash box TB is required. As the allowable weight, for example, a weight that does not exceed a load bearing a capacity of the trash box TB is set. Consider a case where the judgment element is the accommodation rate. If the accommodation rate is over a tolerance rate (e.g., 80%), it is determined that the collection of the trash box TB is required. Consider a case where the judgment element is the residence time. If the residence time exceeds an allowable duration, it is determined that the collection of the trash box TB is required. Consider a case where the judgment element is the concentration of the specific gas. If the concentration is over a tolerance concentration, it is determined that the collection of the trash box TB is required.

When two or more trash box TB are set in one installation space 5, the processing of the step S12 is executed for each trash box TB. If the judgement result of the step S12 is negative, the routine shown in FIG. 8 ends. If the judgement result of the step S12 is positive, it is determined whether the regular collection is scheduled (step S13). The processing of the step S13 is executed based on the schedule data SCH (i.e., the day of week and the time zone data) acquired in the step S11 and the present time. If a time difference from the present time to the regular collection time is less than a tolerance, it is determined that the regular collection is scheduled. In this situation, the routine shown in FIG. 8 ends.

If the judgement result of the step S13 is negative, the collection request RPU is transmitted to the management server 1 (step S14). As described above, the collection request RPU includes the location data of the facility 4A (the space 5A), the number data of the trash box TB to be collected, and the type data of the trash box TB to be collected.

### 3-2. Details of the Step S2

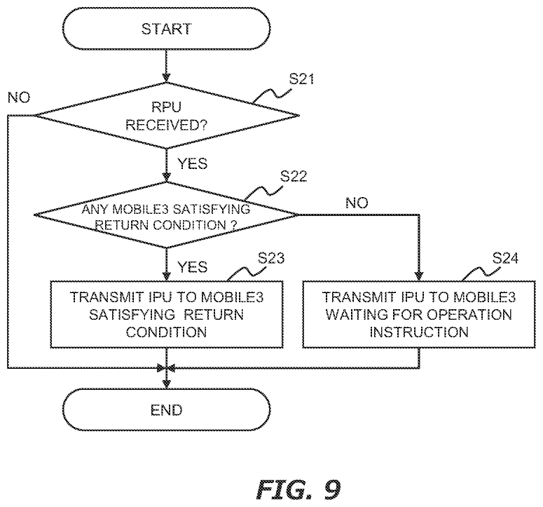

FIG. 9 is a flowchart illustrating an example of processing executed by the data processing device 14 (the processor 14a) of the management server 1. Note that the routine shown in FIG. 9 is repeatedly executed at a predetermined control cycle.

In the routine shown in FIG. 9, first, it is determined whether the collection request RPU has been received (step S21). When the management server 1 receives the collection request RPU from the facility 4, it is determined that the collection request RPU has been received. If the management server 1 has received the collection status data CND from the facility 4, based on this collection status data CND, it is determined whether the collection request RPU has been received. The determination method applied in this case includes the method described in the step S12 of FIG. 8.

If the judgement result of the step S21 is negative, the routine shown in FIG. 9 ends. If the judgement result in the step S21 is positive, it is determined whether the mobile 3 satisfying the return condition exists (step S22). The judgement of the step S22 is executed based on the mobile data MOB and the location data of the facility 4 included in the collection request RPU. The mobile 3 satisfying the return condition is, for example, the mobile 3 satisfying all the following conditions (1) to (3).

(1) The mobile 3 is traveling according to the operation instruction based on another collection request RPU (e.g., the collection request RPU1) which is different from the collection request RPU (e.g., the collection request RPU2) that has been received in the step S21.
(2) In the room of the mobile3, the number of vacant pedestals 35b corresponding to the total number of the trash box TBs to be collected remain vacant.
(3) The distance from the current location of the mobile 3 to the position of the facility 4 included in the collection request RPU (e.g., the collection request RPU2) received in the step S21 is shorter than the distance of another mobile 3 in a standby state.

If the judgement result of the step S22 is positive, the collection order IPU is transmitted to the mobile 3 satisfying the return conditions (step S23). As described above, the collection order IPU includes the location data of the facility 4A in which the trash box TB to be collected is installed, the number data of the trash box TB to be collected, and the type data of the trash box TB. The collection order IPU may include the location data of the outbound route and return route.

When a plurality of mobile 3 satisfying return conditions are present, for example, one mobile 3 is squeezed using the following conditions (4) and (5). For example, a mobile 3 satisfying the following condition (5) and having the shortest time required for the following condition (4) is selected as the mobile 3 in charge of the collection request RPU. Note that to the mobile 3 satisfying the following condition (5), the replenishment order IRS is transmitted in addition to the collection order IPU.

(4) Time required from the current location of the mobile 3 to the position of the facility 4 included in the collection request RPU (e.g., the collection request RPU2) that was received in the step S21.
(5) In the room of the mobile 3, there are as many vacant trash box TBs left in the room of the mobile 3 corresponding to the total number of replenishments.

If the judgement result of the step S22 is negative, the collection order IPU is transmitted to the mobile 3 waiting for the operation instruction (step S24). The selection of the mobile 3 in charge of collection order IPU is performed, for example, by using the above condition (2). When a plurality of mobile 3 waiting for the operation instruction exist, for example, one mobile 3 is squeezed using the above conditions (4) and (5). When the narrowing-down is performed using the condition (4), it is preferable that traveling time of the mobile 3 in the standby area 22 is also considered. Note that to the mobile 3 satisfying the following condition (5), the replenishment order IRS is transmitted in addition to the collection order IPU.

### 3-3. Details of the Step S3

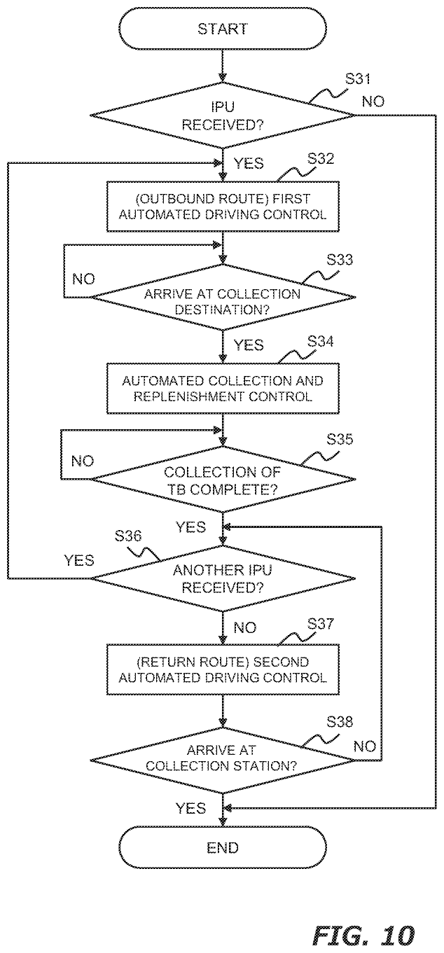

FIG. 10 is a flow chart illustrating an exemplary process performed by controller 33 of mobile 3, i.e., the processors 36a and 37a.FIG. 9 is a flowchart illustrating an example of processing executed by the controller 33 (the processors 36a and 37a) of the mobile 3. Note that the routine shown in FIG. 10 is repeatedly executed at a predetermined control cycle.

In the routine shown in FIG. 10, first, it is determined whether the collection order IPU has been received (step S31). If the judgement result of the step S31 is positive, the first automated driving control is executed (step S32). In the first automated driving control, first, a driving plan in the outbound route from the current location of the mobile 3 to the facility 4 is generated based on the collection order IPU.

The driving plan consists of plurality of events that are executed sequentially. The plurality of events includes, for example, an acceleration event, a deceleration event, a lane maintaining event, a lane change event, and the like. The acceleration event is an event to accelerate the mobile 3. The deceleration event is an event to slow down the mobile 3. The lane maintaining event is an event in which the mobile3 is driven so as not to deviate from a lane along which the mobile 3 is traveling. The lane change event is an event in which the mobile 3 is driven to change a lane along which the mobile 3 is traveling.

In the first automated driving control, a driving trajectory of the mobile 3 is generated based on the generated driving plan. The driving trajectory is a collection of target positions where a reference position of the mobile 3 (e.g., a location of a center of gravity of the mobile 3) should reach. The target positions are set every time a predetermined time elapses with reference to the present time.

The driving trajectory for the lane maintaining event is generated, for example, as follows. First, a driving mode is determined. The driving mode includes, for example, a cruise control mode, a following travel mode, a curve travel mode, and the like. The cruise control mode is a driving mode that is determined when there is no other mobile (e.g., a vehicle) in front of the mobile 3 and on the lane along which the mobile 3 travels. The following travel mode is a driving mode that is determined when the other mobile is traveling in front of the mobile 3 and on the lane along which the mobile 3 travels. The curve travel is a driving mode that is determined when the mobile 3 encounters a curve. If the driving mode is determined, target speed (or target acceleration) of the mobile 3 is calculated. Based on this target speed, the driving trajectory is generated.

The driving trajectory for the lane change is generated, for example, as follows. First, it is confirmed that there is no other mobile interfering with the lane change event (hereinafter also referred to as an “interfering mobile”) around the mobile 3. The interfering mobile is another mobile (e.g., a vehicle) that travels in the same direction as the mobile 3. An absence of the interfering vehicle means that the interfering mobile does not exist within a predetermined distance in front of the mobile3 in the lane on which the mobile 3 travels, and the interfering mobile does not exist within a predetermined distance in front of and behind the mobile 3 in a lane on which the mobile 3 travels after the lane change. If no interfering mobile exist, a start position of the lane change event is set. Subsequently, the target speed and target yaw rate of the mobile 3 of this start position are calculated. Then, the driving trajectory is generated based on the target speed and target yaw rate.

In the first automated driving control, the driving device 34 (i.e., the motor 34b, the steering device 34c and the brake device 34d) is controlled such that the mobile 3 travels along the generated driving trajectory. For example, a deviation of the driving trajectory and the mobile 3 is calculated. Examples of the deviations include a lateral deviation, a yaw angle deviation (an azimuth angle deviation) and a velocity deviation. Then, in the first automated driving control, a control amount of the driving device 34 is calculated such that the deviations of the driving trajectory and the mobile 3 is reduced.

After the processing of the step S32, it is determined whether the mobile 3 has arrived at a collection destination (step S33). The collection destination is a position of the facility 4(the installation space 5) contained in the collection order IPU. The processing of the step S33 is repeatedly executed until the mobile 3 arrives at the collection destination.

If the judgement result of the step S33 is positive, the automated collection and replenishment control is executed (step S34). In the automated collection and replenishment control, first, it is confirmed that the door 43 is opened, and it is confirmed that the trash box TB to be collected is present in the installation space 5. The recognition of the door and the trash box TB is performed based on recognition data from the sensors 31.

In the automated collection and replenishment control, the door 35a and the slide device 35c are subsequently controlled such that the pedestal 35b on which no trash box TB is seated is pulled out to the side of the mobile 3. The position of the mobile 3 may be adjusted such that the vacant pedestal 35b is in front of the trash box TB to be collected. In this case, an adjusting the position of the mobile 3 is performed by the control of the motor 34b.

In the automated collection and replenishment control, the robot arm device 35d is subsequently controlled such that the trash box TB is placed on the pedestal 35b. After that, the door 35a and the slide device 35c are controlled, and the pulled-out pedestal 35b is accommodated in the mobile 3. Thus, the trash box TB is collected in the mobile 3.

If the replenishment order IRS has been received in addition to the collection order IPU, the collection of the trash box TB is performed after the replenishment of the vacant trash box TB. In this case, first, the slide device 35c is controlled such that the pedestal 35b on which the vacant trash box TB seats is pulled out to the side of the mobile 3. The position of the mobile 3 may be adjusted such that the pedestal 35b on which the vacant trash box TB seats is positioned in front of the installation space 5. In this case, the adjusting the position of the mobile 3 is performed by the control of the motor 34b.

In the automated collection and replenishment control, the robot arm device 35d is subsequently controlled, whereby the vacant trash box TB is installed in the installation space 5. After that, the door 35a and the slide device 35c are controlled, and the pulled-out pedestal 35b is accommodated in the mobile 3.

After the processing of the step S34, it is determined whether the collection of the trash box TB has been completed (step S35). If the replenishment order IRS has been received in addition to the collection order IPU, it is determined whether the collection and replenishment have been completed. The processing of the step S34 is repeatedly executed until the collection (and the replenishment) has been completed.

If the judgement result of the step S35 is positive, it is determined whether another collection order IPU has been accepted (step S36). If the judgement result of the step S36 is positive, processing of the steps S32 to S35 is executed.

If the judgement result of the step S36 is negative, the second automated driving control is executed (step S37). In the second automated driving control, first, a driving plan in the return route from the current location of the mobile 3 to the trash collection point 2 is generated. The processing after the generation of the driving plan is the same as the processing in the first automated driving control described in the step S32.

After the processing of the step S37, it is determined whether the mobile 3 has arrived at the trash collection point 2(the standby area 22) (step S38). The processing of the step S38 is repeatedly executed until the mobile 3 arrives at the trash collection point 2. If the judgement result of the step S38 is positive, the processing of the routine shown in FIG. 10 ends.

### 4. Effect

According to the embodiment described above, the trash box TB installed in the installation space 5 is collected by the mobile 3. Here, the Installation space 5 is located in the facility 4. This frees the trash box TB from a manual operation of carrying it out of the facility 4 to a predetermined collection area. Therefore, the labor of the human in the facility 4 can be reduced. In addition, in the installation space 5, a loading of the trash box TB to the mobile 3 and an unloading of the vacant trash box TB are autonomously performed. Therefore, the labor of the occupant of the mobile 3 can be reduced. Furthermore, according to the embodiment, the travel of the mobile 3 along the outbound route and the return route is performed autonomously. Therefore, it is possible to drive the mobile 3 unattended to enhance the convenience of the collection and replenishment service.

What is claimed is:

1. A system to collect a trash discarded by a facility, comprising:
a trash box placed in a space facing a road for the mobile in the facility;
a computer of the facility configured to acquire collection status data of a trash in a trash box installed in the space;
a mobile including an automatic collection device of the trash box; and
a management server configured to communicate with the mobile and the computer of the facility,
wherein the management server or the computer of the facility is configured to determine whether a collection of the trash box installed in the space is required based on a comparison a judgment element calculated based on the collection status data with a judgment threshold set for each judgment element,
wherein, when it is determined that collection of the trash box installed in the space is required, the management server transmits a collection order to collect the trash box as a container to be collected to the mobile; and
wherein, the automatic collection device is configured to execute automated replenishment control of the container to be collected in the installation space of the container to be collected if the mobile receives the collection order.

2. The system according to claim 1,
wherein the mobile further includes an automated driving device,
wherein the automated driving device is configured to execute first automated driving control from a current location of the mobile to the installation space and second automated driving control from the installation space to a trash collection point when the mobile receives the collection order.

3. The system according to claim 1,
wherein the container to be collected includes at least two types of trash boxes set according to types of trashes,
wherein the management server or the computer of the facility individually determines for each of the at least two types of the trash boxes whether the collection of the trash box is required based on the comparison between the judgment element with the judgment threshold set for each judgment element,
wherein a default value of the judgment threshold is individually set according to the types of trashes.

4. The system according to claim 1,
wherein the default value of the judgment threshold is individually set according to the types of trashes,
wherein, when the management server receives a request for changing the judgment threshold the from facility, the management server is configured to change the judgment threshold to a value other than a default value in response to the request.

5. The system according to claim 1,
wherein the facility includes a first facility and a second facility,
wherein the mobile includes a first mobile and a second mobile,
wherein the trash box includes a first trash box installed in the space of the first facility and a second trash box installed in the space of the second facility,
wherein the management server is configured to:
if it is determined that the collection of the first trash box is required, transmit a first collection order that is the collection order for the first trash box to the first mobile;
if it is determined that the collection of the second trash box is required during the collection of the first trash box by the first mobile based on the first collection order, determine whether a return condition for the first mobile is satisfied;
if it is determined that the return condition is satisfied, transmit a second collection order that is the collection order for the second trash box to the first mobile; and
if it is determined that the return condition is not satisfied, transmit the second collection order to the second mobile.

6. The system according to claim 1,
wherein the judgment element is at least one selected from a weight of the container to be collected, an accommodation rate of the trash in the container to be collected, a residence time of the trash in the container to be collected, and a concentration of a specific gas around the container to be collected.

7. A method to collect a trash discarded by a facility by collecting a trash box installed in a space facing a road for a mobile in a facility by a mobile,
wherein the facility comprises a data acquiring device,
wherein the data acquiring device configured to acquire collection status data of a trash in a trash box installed in the space,
wherein the mobile includes an automatic collection device of the trash box,
wherein a management server or a computer of the facility determines whether a collection of the trash box installed in the space is required based on a comparison a judgment element calculated based on the collection status data with a judgment threshold set for each judgment element,
wherein, when it is determined that collection of the trash box installed in the space is required, the management server transmits a collection order to collect the trash box as a container to be collected to the mobile,
wherein the automatic collection device executes automated replenishment control of the container to be collected in the installation space of the container to be collected if the mobile receives the collection order.

8. The method according to claim 7,
wherein the mobile further includes an automated driving device,
wherein the automated driving device executes first automated driving control from a current location of the mobile to the installation space and second automated driving control to a trash collection point when the mobile receives the collection order.
